(19) United States
(12) Patent Application Publication
(10) Pub. No.: US 2010/0300003 A1
(43) Pub. Date: Dec. 2, 2010

(54) Door system with interchangeable panel inserts

(76) Inventor: Estell Goode, Baltimore, MD (US)

Correspondence Address: JOHN E. SIMMS JR., 6803 YORK ROAD, SUITE 202, BALTIMORE, MD, 21212, US

(21) Appl. No.: 12/800,666

(22) Filed: May 20, 2010

Related U.S. Application Data
(60) Provisional application No. 61/217,178, filed on May 28, 2009.

(51) Int. Cl. E06B 3/72; E06B 1/04

(52) U.S. Cl. 49/504

(57) ABSTRACT

A door system includes a door body and panel inserts. A first side edge of the door body includes door hinges and a second side edge is provided with one or more slots. The door body includes one or more windows, each communicating with a slot. A channel is provided on the inner aspect of each window. Each of the panel inserts includes a frame defining a central opening. The frame may be received into the slot and rest in snug fitting engagement in the channel, disposing the central opening within the window. A mesh screen is mounted on the frame of one or more panel inserts and occupies the central opening. An air impervious pane is likewise mounted on the frame of other panel inserts. The panel inserts may be interchangeably installed and are retained in place by a slidable bolt mounted on the second side edge.

### CROSS REFERENCE TO OTHER APPLICATIONS

Applicant claims the benefit of Provisional Patent Application No. 61/217,178, filed 28 May 2009, by Estell Goode and Alice Goode.

### BACKGROUND

1. Field of the Invention

The invention relates generally to door systems and more particularly to a door system having interchangeable panel inserts.

2. Description of the Background

With the change of seasons, in a temperate climate zone, it is desirable for a dwelling to have an exterior door which will allow air to pass through, for ventilation, in the summer and which also will prevent the passage of air, for retaining heat, in the winter. The dual function is typically accomplished by providing a door system consisting of a permanently installed door having one or more windows together with a set of interchangeable panel inserts, which are adapted for installation on the door. For use in winter, a panel insert, for each window, includes an air impervious and usually transparent pane mounted in a frame designed to form a barrier in the window. For use in summer, a panel insert, for each window includes a mesh screen to form a barrier, as to insects and particles, but allowing the passage of air for ventilation.

A door system of this type is typically installed on the outer portion of an exterior door jamb, with a locking security door being installed on the inner portion of the exterior door jamb. The door system functions as a storm door protecting the security door from winter weather, when the panel inserts with air impervious panes are in place. The air impervious panes also block drafts to minimize energy loss. In summer, with panel inserts having mesh screen in place, the storm door admits air for ventilation while maintaining a barrier against insects and particles. The interchangeable panel inserts are provided in pairs with one pair corresponding to each window, in the door. Each member of a pair of panel inserts includes a frame of like dimensions configured to fit snugly in a window with one member having a mesh screen mounted in the frame and the other member having an air impervious pane mounted in the frame. As part of the preparation for the change of seasons, the homeowner will remove one member of a pair of interchangeable panel inserts and install the other.

The interchangeable panel inserts are typically retained in place by a plurality of fastening means distributed on the perimeter of the window. One means consists of a plurality of elongate blocks having one end secured to the door, by a screw driven into the door proximate to the window and having the other end extending adjacent to the frame of the panel insert. After a relatively short period of time, the repeated extraction and insertion of the screw, with each seasonal change of the panel insert, exhausts the capacity of the screw to remain secure in the door. In addition, the repeated shocks delivered to the door, as individuals open and close the door during normal use, adds stress to the fastening means contributing to premature failure.

Another fastening means employs spring biased plugs extending outward from the frame of the panel inserts. Corresponding holes are provided in the inner aspect of the window, for receiving the extending portion of the plugs. Typically, no more that four plugs are mounted, on each frame, so that an individual, working alone, may place one edge of a panel insert frame in alignment with the inner aspect of the window, set the plugs in the holes, and then manually withdraw the two opposite plugs while rocking the panel insert into the window, to align the remaining plugs with the holes, and releasing the plugs to secure the panel insert in place. This fastening means offers a more secure system; however, any warping, twisting, or swelling, of the door or the insert panel can adversely affect the alignment of the plugs and holes or adversely affect the snug fitting relation of the insert panel with the window. A similar method includes a rotating tab mounted on the frame of the panel insert, such that manual rotation, of the tab causes a flange portion to advance outward from the edge of the frame. A corresponding slot formed in the inner aspect of the window is adapted to receive the flange and retain the panel insert in place. This method suffers from the same drawbacks as the system of spring biased plugs and corresponding holes.

Finally, a system has been developed which allows the winter and summer panel inserts to be simultaneously installed, in a door, in the manner of a double hung sash, such that one or the other of the panel inserts may be selectively moved into position occupying a window, as is appropriate for the season. This system avoids the necessity to remove and store one of the pair of panel inserts, in the off-season; however, the presence of the unused panel insert limits the available size of the window to be occupied by the desired panel insert.

There is a need for a door system with interchangeable panel inserts having a convenient and secure fastening means, for retaining the panels in place.

There is a need for a door system with interchangeable panel inserts having a durable and dependable fastening means, for retaining the panels in place.

There is a need for a door system with interchangeable panel inserts which reduces the tendency of panel inserts to warp and twist.

### SUMMARY OF THE INVENTION

The present invention is a door system comprising a planar and rigid door body together with at least two interchangeable panel inserts. The door body is formed with two side edges and is designed for fitting a door jamb. A first side edge is provided with hinge means configured for rotatable mounting on a door jamb, for allowing the door to rotate between a closed position adjacent to the door jamb and an open position displaced from the door jamb. A second side edge is spaced apart from and generally parallel to the first side edge. The door body is provided with one or more windows and with one or more slots in the second side edge, the slots being in a one-to-one correspondence with the windows and being in communication with the windows. The panel inserts comprise a rigid frame having a central opening occupied by a barrier mounted on the frame. The frames are designed to be slidably received into a slots. A channel is formed on the inner aspect of each of the windows. The channel is designed to partially receive a frame in snug fitting engagement to dispose the panel insert within a window. At least one of the panel inserts includes a barrier formed of mesh screen and at least one of the panel inserts includes a barrier formed of an air impervious pane. The air impervious pane may be transparent for admitting light. The second side edge of the door body may be provided with one or more fastening means mounted adjacent to an end of a slot for retaining the panel inserts in place. The fastening means may include a slidable bolt mounted in a well and the frames of the panel inserts may be provided with one or more notches located such that a panel insert may be inserted in one of the slots thereby disposing the notch in a position to cooperate with the fastening means adjacent to the end of the slot to receive the bolt for retaining the panel insert in place.

It is an object of the present invention to provide a door system with interchangeable panel inserts having a convenient and secure fastening means, for retaining the panels in place.

It is an object of the present invention to provide a door system with interchangeable panel inserts having a durable and dependable fastening means, for retaining the panels in place.

It is an object of the present invention to provide a door system which reduces the tendency of panel inserts to warp and twist.

### BRIEF DESCRIPTION OF THE DRAWINGS

The present invention may be more fully understood and appreciated with reference to the accompanying drawings in which:

FIG. 1 is a perspective view of an embodiment of a door system of the present invention having two windows and illustrating insertion of two panel inserts with mesh screen barriers.

FIG. 2 is a perspective view of two panel inserts having air impervious pane barriers.

FIG. 3 is a perspective view of a portion of a second side edge of a door body showing an embodiment of fastening means for retaining a panel insert in place.

FIG. 4 is a partially broken away perspective view of a portion of a second side edge of a door body showing an embodiment of fastening means having a bolt with a stud and an interlocking track.

FIG. 5 is a perspective view of a bolt with a stud of an embodiment of the present invention.

FIG. 6 is a perspective view of a portion of a panel insert on an embodiment of the present invention.

FIG. 7 is a perspective view of a door body having two windows with panel inserts having air impervious pane barriers inserted and retained in place.

### DETAILED DESCRIPTION OF THE PREFERRED EMBODIMENT

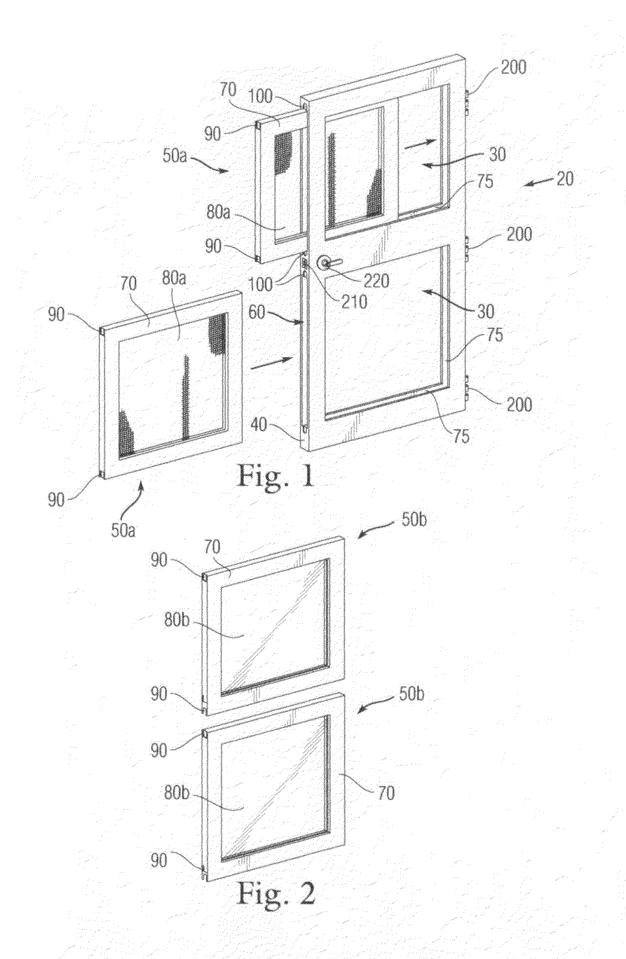

The present invention is a door system having interchangeable panel inserts to occupy windows provided in a door. Each of the panel inserts includes a barrier. It is intended that the door system include pairs of panels with one member having a mesh screen barrier and other having an air impervious barrier. The panel inserts may be readily interchanged to provide a door with screen barriers or a door with air impervious barriers, as appropriate for the season. An embodiment of the present invention is shown in FIG. 1, which depicts a door body 20 having two windows 30 and two side edges, a first side edge (not shown) and a second side edge 40. Panel inserts comprise summer panel inserts 50a, shown in FIG. 1, and winter panel inserts 50b, shown in FIG. 2. The door body 20 is formed of rigid material such as wood, plastic, aluminum, or other metal, and is generally planar in shape. The door body 20, shown in FIG. 1 is rectangular and includes two rectangular windows 30, with one above the other, but it is to be understood that the door body 20 could have other shapes, such as a half round top and other arrangements of windows having varied shapes and quantity are contemplated by the present invention.

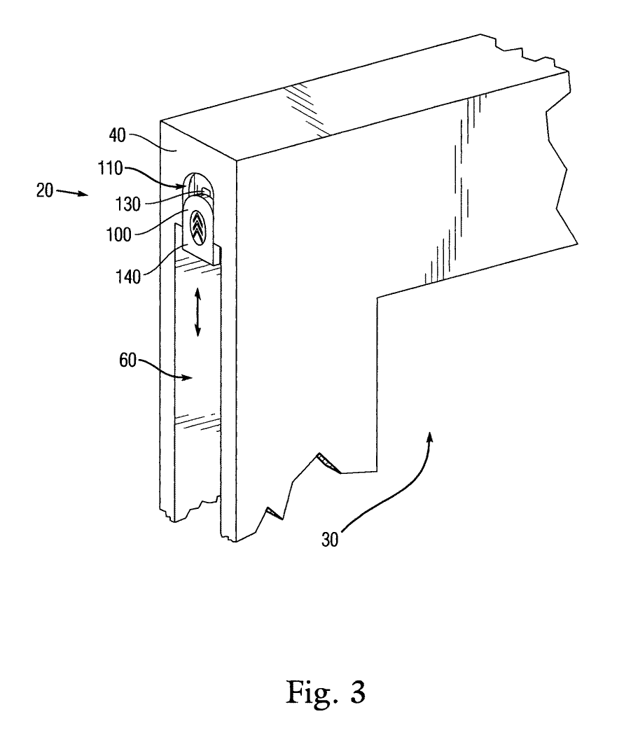

The second side edge 40 includes a number of slots 60 in one-to-one correspondence with the windows 30. In FIG. 1, a lowermost one of the slots 60 is visible. An uppermost one of the slots 60 is obscured by a summer panel insert 50a, but is visible in FIG. 3. The slots 60 are designed to slideably receive the summer panel inserts 50a, as shown in FIG. 1. It is preferred that the winter panel inserts 50b, shown in FIG. 2, be of like dimensions for being slidably received into the slots 60 in like manner. The summer panel inserts 50a are formed with a rigid frame 70 defining a central opening occupied by a barrier. It is preferred that the frame 70 be formed of the same material used for forming the door body 20. The barrier may be designed to allow a flow of air for ventilation, such as a mesh screen 80a mounted to the frame 70 of summer panel inserts 50a, shown in FIG. 1, or the barrier may be designed to block air flow such as the air impervious pane 80b mounted to the frame 70 of winter panel inserts 50b, as shown in FIG. 2. The air impervious pane 80b is preferably transparent material, such as glass or transparent plastic such as Plexiglas®. The inner aspects of the windows 30 are provided with a channel 75 designed for partially receiving the frame 70 of either the summer panel inserts 50a or the winter panel inserts 50b in snug fitting engagement for forming a seal between the frame 70 and the inner aspect of a one of the windows 30. A gasket (not shown) may be provided on the inner aspect of the windows 30 adjacent to the channels 75 to enhance the seal.

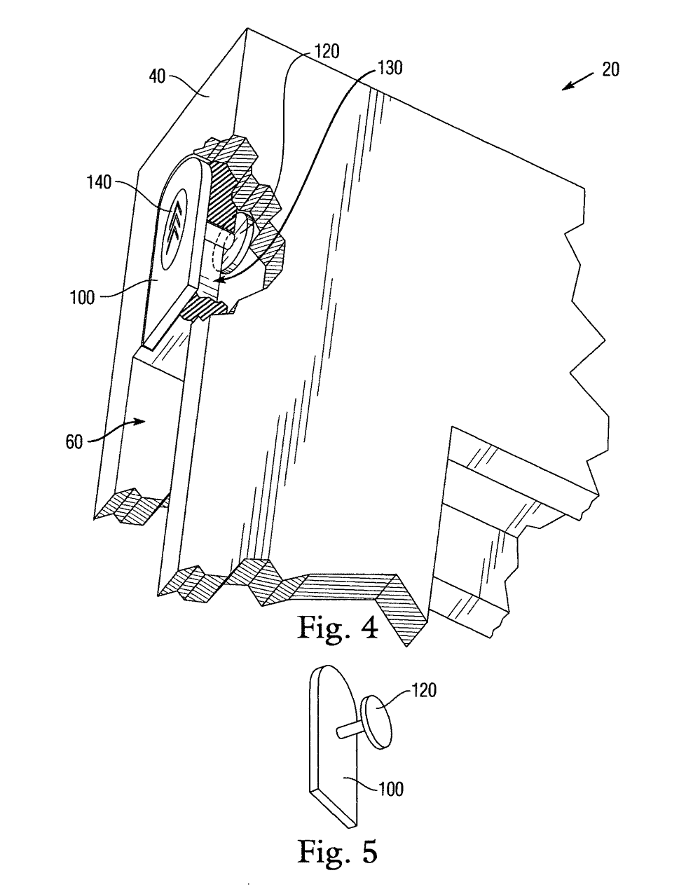

It is preferred that the door body 20 be provided with fastening means for retaining the panel inserts 50a and 50b in place. An embodiment employing a slidable bolt 100 is shown in FIG. 3, which shows a portion of a door body 20 including an uppermost one of the slots 60. The bolt 100 is preferably formed of a slab of metal having a top side and bottom side. A well 110 is provided in the second edge 40 adjacent to an end of the uppermost one of the slots 60 for receiving the bolt 100. The bolt 100 is slidably retained in the well 110 such that the bolt may be manually advanced to a closed position partially outside the well 110, as shown in FIG. 3, or manually retracted to an open position within the well 110, as shown in FIG. 4. The bolt 100 may be slidably retained in the well 110 by a stud 120 projecting from the bottom side of the bolt 100, shown in FIG. 5, the stud 120 being slidably retained by a central track 130 provided at the base of the well 110, shown in FIGS. 3 and 4. It is preferred that the top side of the bolt 100 be provided with a cupped finger grip 140 for facilitating manual manipulation of the bolt 100.

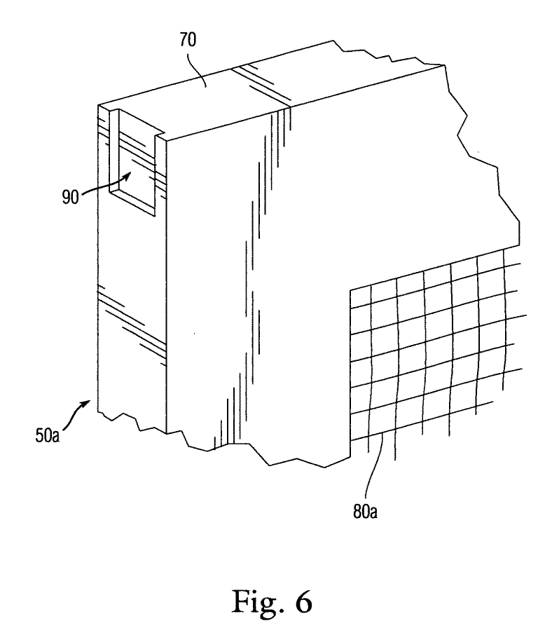

It is desirable, for aesthetic purpose that the frame 70 of each of the panel inserts 50a and 50b be sized to lie flush with the second edge 40 when inserted into the slots 60; therefore, it is preferred that each frame 70 have two notches 90, shown in FIG. 6, disposed such that one of the notches 90 is aligned and adjacent to a well 110 for receiving the bolt 100 into the one of the notches 90 in flush fitting engagement for retaining the panel inserts 50a and 50b in place.

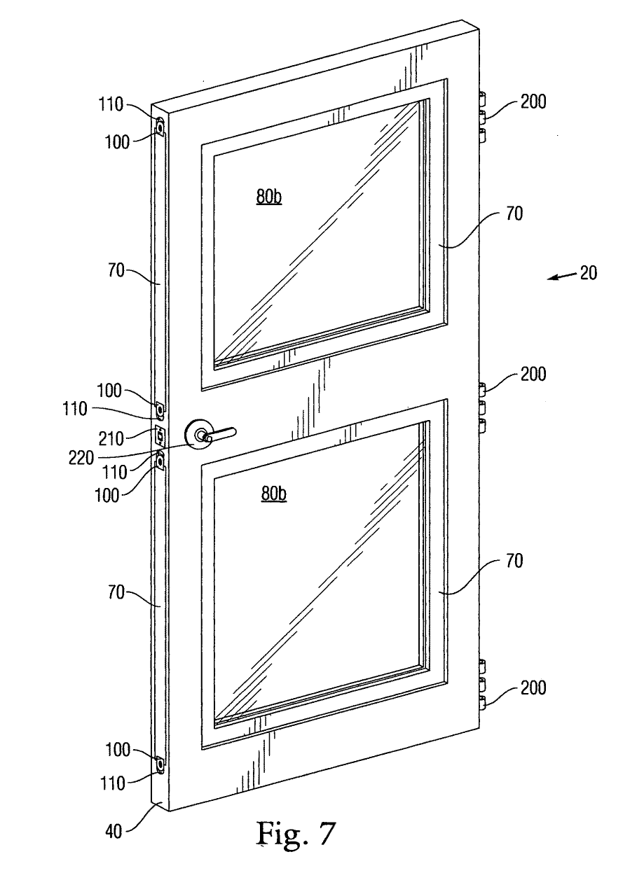

It is intended that the door body be designed for standard installation in a door jamb. It is preferred that the first side edge have hinge means such as hinges 200 and that the second side edge 40 include latch plate 210 with a cooperating door handle 220, as shown in FIG. 7.

It is intended that the door system of the present invention would include summer panel inserts 50a and winter panel inserts 50b for each of the windows 30. FIG. 7 shows a door body 20 with winter panel inserts 50b installed and retained by fastening means. The panel inserts may be locked in place with the fastening means and securely retained during frequent and vigorous use of the door. Upon the change of seasons, the bolt means may be easily released to allow removal of one set of seasonal panel inserts and installation of panel inserts appropriate to the approaching season. The fastening means provides easily operable procedure for releasing and securing the panel inserts. The fastening means is durable and requires no tools for removing and installing the panel inserts. The channel 75 contacts and supports the frame 70 over the entire perimeter to maintain a weather seal and reduce warping and twisting of the frame 70. Having fully described the present invention, it may be understood that minor variations may be introduced without departing from the scope of the invention as disclosed and claimed herein.

I claim:

1. A door system comprising:
a rigid door body and at least two interchangeable panel inserts;
said door body being generally planar and having a first side edge and a second side edge;
said second side edge being spaced apart from and generally parallel with said first side edge;
said first side edge being provided with hinge means configured for rotatable mounting on a door jamb;
said door body having one or more windows;
said second side edge having one or more slots, in one-to-one correspondence with said windows and communicating with said windows;
said door body having a channel formed on the inner aspect of each of said windows;
said panel inserts being adapted for being received in said slots and for slidable snug fitting partial engagement within said channel;
said panel inserts comprising a rigid frame defining a central opening;
each of said panel inserts being provided with a barrier mounted to said frame and occupying said central opening;
said barrier being composed of an air impervious pane or a mesh screen;
whereby said panel inserts may be selectively removed and installed to provide the said door system with a window having an air impervious barrier or a mesh screen barrier.

2. The door system of claim 1 further comprising one or more fastening means for retaining said panel inserts in place.

3. The door system of claim 2 wherein each of said fastening means comprises:
a well provided on said second side edge adjacent to an end of a one of said slots;
a bolt slidably mounted in said well and configured for being manually advanced to a closed position partially outside said well and for being manually retracted to an open position within said well;
whereby a one of said panel inserts may be inserted into one of said slots with said frame being partially received into said channel and said bolt may be advanced from said open position to said closed position, for retaining said panel insert in place.

4. The door system of claim 3 wherein said fastening means further comprises:
a notch formed in the frame of each panel insert;
said notch being located such that each panel insert may be inserted into a one of said slots so as to dispose said notch adjacent to said well for receiving said bolt into said notch.

5. The door system of claim 3 wherein:
said well further includes a track and said bolt further includes a stud for slidably engaging said track, said track being adapted for retaining said stud in slidable engagement.
